(19) United States
(12) Patent Application Publication
(10) Pub. No.: US 2020/0055453 A1
(43) Pub. Date: Feb. 20, 2020

(54) ON-BOARD CAMERA

(71) Applicant: ISUZU MOTORS LIMITED, Shinagawa-ku, Tokyo (JP)

(72) Inventor: Shigeki MATSUO, Ayase-shi, Kanagawa (JP)

(21) Appl. No.: 16/606,598

(22) PCT Filed: Apr. 12, 2018
(86) PCT No.: PCT/JP2018/015314

§ 371 Date: Oct. 18, 2019

(30) Foreign Application Priority Data
Apr. 19, 2017 (JP) 2017-082481

(51) Int. Cl. B60R 1/00; B60R 11/04; B60R 11/00; H04N 5/225; H04N 13/207

(52) U.S. Cl. CPC B60R 1/00; B60R 11/04; B60R 11/00; H04N 5/2252; B60R 2011/0005; H04N 13/207; B60R 2300/105; B60R 2300/107; B60R 2300/802; H04N 5/2253

(57) ABSTRACT

An on-board camera for capturing an image of an area in front of a vehicle is provided with a camera body, a housing part, and leg parts. The leg parts extend from the housing part toward an upper surface of a dashboard and support the housing part at a positions where the housing part is placed within a wiping range of a wiper on a windshield when the housing part is viewed from one direction. A space surrounded by the dashboard, the housing part, and the leg parts is formed. A driver seated in the driver's seat enables to see an area in front of the vehicle through the windshield from the space.

### TECHNICAL FIELD

The present disclosure relates to an on-board camera, and more particularly to an on-board camera that captures an image of an area in front of a non-bonnet type vehicle.

### BACKGROUND ART

An on-board camera installed on an upper surface of a dashboard of a non-bonnet type vehicle such as a truck or a bus has been proposed (see, for example, Patent Literature 1). The on-board camera captures an image of a face of a driver.

### CITATION LIST

### Patent Document

Patent Literature 1: JP-A-2013-095195

### SUMMARY OF THE INVENTION

### Technical Problem

In addition to the camera for monitoring the driver, there are cameras that capture an image of an area in front of the vehicle and monitor lanes, obstacles, and the like present on the ground in front of the vehicle. It is desirable that the on-board camera for monitoring the ground in front of the vehicle is installed in a cabin that is not exposed to wind and rain. Furthermore, it is more desirable that the on-board camera captures the image of the area in front of the vehicle over a wiping range of a wiper on a windshield in the cabin.

However, since the cabin is at a high position in the non-bonnet type vehicle, if the on-board camera is installed on a ceiling of the cabin as in a case of a bonnet-type vehicle, it is necessary to direct a camera lens downward in order to satisfy the above requirements. As the camera lens is inclined, an image-capturing range of the camera becomes narrow. Further, an upper part of the windshield is distorted, and an image captured by the on-board camera is also distorted along with the distortion. That is, when the on-board camera is installed on the ceiling of the cabin in the non-bonnet type vehicle, there is a problem that the ground in front of the vehicle cannot be monitored with high accuracy.

On the other hand, when the on-board camera is installed on the upper surface of the dashboard as described in Patent Literature 1, it is necessary to support the on-board camera at a position separated upward from the upper surface of the dashboard in order to satisfy the above-described demand. In this case, the on-board camera may obstruct a field-of-view of an occupant (particularly the driver) seated on a seat in the cabin.

An object of the present disclosure is to provide an on-board camera capable of sufficiently ensuring a field-of-view of an occupant of a vehicle to clearly capture a wide range in front of the vehicle and monitor the front of the vehicle with high accuracy.

### Solution to Problem

There is provided an on-board camera that captures an image of an area in front of a vehicle. The on-board camera includes a camera body, a housing part that houses the camera body, and a leg part that extends from the housing part toward an upper surface of a dashboard of the vehicle. The leg part supports the housing part at a position where the housing part is placed within a wiping range of a wiper on a windshield of the vehicle when the housing part is viewed from a front-rear direction of the vehicle, a space surrounded by the dashboard, the housing part, and the leg part is formed, and an occupant seated on a seat of the vehicle enables to see an area in front of the vehicle through the windshield from the space.

### Advantageous Effects of the Invention

According to the on-board camera of the present disclosure, since the space surrounded by the dashboard, the housing part, and the leg parts is formed, it is possible to sufficiently ensure the field-of-view of the occupant through the space. Therefore, the on-board camera can be installed at a position, where the field-of-view of the occupant is blocked, above the upper surface of the dashboard. Accordingly, this is advantageous for capturing an image of the area in front of the vehicle through the wiping range of the wiper of the windshield without inclining the camera lens downward. Further, even if the cabin is at a high position from the ground as in a non-bonnet type vehicle, it is possible to widen the captured image-capturing range in front of the vehicle and make the image clear. Accordingly, the front of the vehicle can be monitored with high accuracy.

### BRIEF DESCRIPTION OF THE DRAWINGS

FIG. 1 is an explanatory diagram illustrating an embodiment of an on-board camera according to the present disclosure.

FIG. 2 is an explanatory diagram illustrating a state in which a driver views the on-board camera of FIG. 1.

FIG. 3 is a cross-sectional view illustrating leg parts of the on-board camera of FIG. 1.

### DESCRIPTION OF EMBODIMENTS

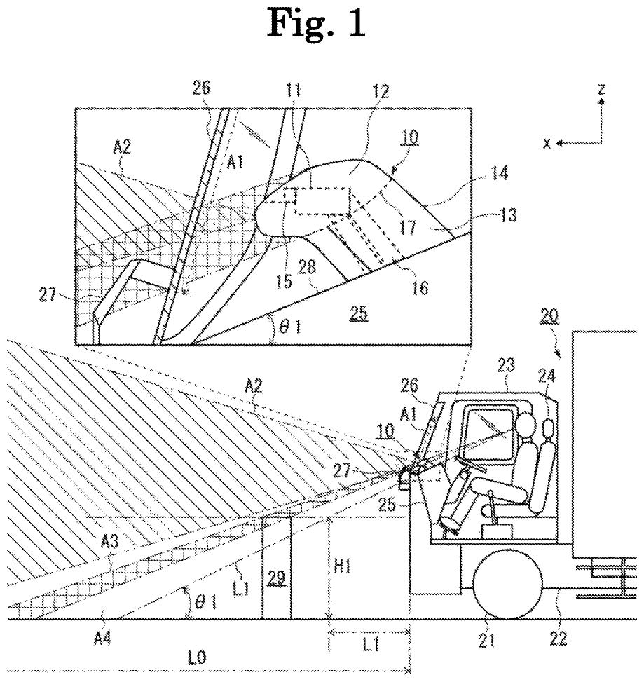

Hereinafter, an embodiment of an on-board camera according to the present disclosure will be described with reference to FIGS. 1 to 3. In FIGS. 1 to 3, x represents a front-rear direction of a vehicle, y represents a left-right direction of the vehicle orthogonal to the x direction, and z represents a vertical direction.

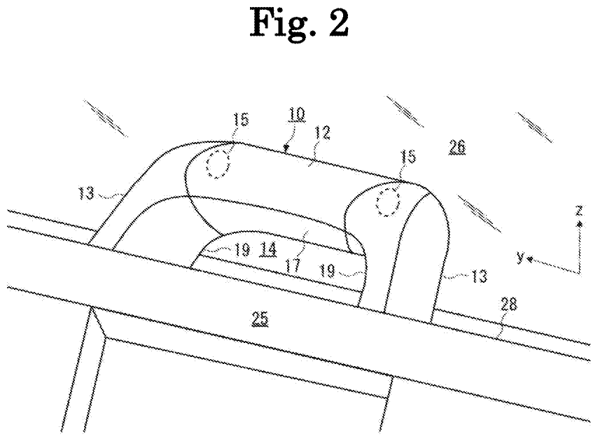

As illustrated in FIGS. 1 and 2, an on-board camera 10 according to the embodiment is mounted on a non-bonnet type vehicle 20 such as a truck or a bus, and is a device that captures an image and monitors an area in front of the vehicle 20.

In the present specification, the front of the vehicle 20 to be monitored by the on-board camera 10 is defined as a range including at least the ground that is separated from a front end of the vehicle 20 by a predetermined distance L0 or more in the x direction toward the front. The predetermined distance L0 is exemplified by a distance sufficient to prevent the vehicle 20 from colliding with an obstacle even when the vehicle 20 starts stopping after detecting the presence of the obstacle on the ground in front. The vehicle 20 is a cab-over type vehicle in which an engine (not shown) is disposed on a front side in the x direction of a chassis 22 that supports wheels 21, and a cabin (driver's cab) 23 is disposed above the engine.

In the present specification, a vehicle in which a bonnet is disposed in front of the cabin is defined as a bonnet type vehicle, and a vehicle in which a bonnet is not disposed in front of the cabin 23 such as a cab-over type vehicle 20 exemplified in the embodiment is defined as the non-bonnet type vehicle. In addition to the truck in the embodiment, a bus, a van, and the like are also exemplified as the non-bonnet type vehicle.

A driver seat 24 is installed as a seat inside the cabin 23, and a dashboard (also referred to as an instrument panel) 25 is disposed in front of the driver seat 24 in the x direction. A windshield 26 is provided above the dashboard 25, and a wiper 27 is installed at a lower end portion of the windshield 26.

The dashboard 25 has an upper surface 28 which extends in the y direction of the vehicle 20 and is inclined with respect to a horizontal plane with an x-direction front end thereof being lowered with respect to an x-direction rear end. An inclination angle θ1 of the upper surface 28 of the dashboard 25 is set to an angle at which it can be confirmed that an object 29 having a height HI or more is present at a location separated from the vehicle 20 by a distance L1 or more in the x direction toward the front when the driver seated on the driver seat 24 visually recognizes the front. (If there is something that can exemplify this object 29, please let me know.) A lower limit value of a field-of-view range of the driver is defined by the inclination of the upper surface 28. L1 in the drawing indicates the lower limit value of the field-of-view range of the driver.

A wiping range A1 of the wiper 27 on the windshield 26 is set. The wiper 27 wipes the fan-shaped wiping range A1 when viewing the windshield 26 in the x direction by reciprocally rotating a wiper arm having a wiping body (wiper blade) at one end around another end located at the lower end of the windshield 26. A lower end of the wiping range A1 is a lower end of the wiping body in a state in which the wiper 27 is not driven.

The on-board camera 10 is installed at a central portion of the upper surface 28 of the dashboard 25 in they direction, and includes a camera body 11, a housing part 12, and leg parts 13. A space 14 surrounded by the dashboard 25, the housing part 12, and the leg parts 13 is formed in the on-board camera 10 when viewed from the x direction.

The camera body 11 is configured by a compound-eye stereo camera, and includes at least two camera lenses 15. In this embodiment, the two camera lenses 15 are separated in they direction and disposed in the housing part 12. A signal line 16 is derived from the camera body 11, and the signal line 16 is connected to a control device of the vehicle 20 via the leg part 13.

The camera lens 15 faces forward in the x direction in a state of not being inclined with respect to the horizontal plane, and captures an image of an image-capturing range A2. The image-capturing range A2 may include at least the front of the vehicle 20 defined above, and in this embodiment, the image-capturing range A2 also includes a region above the ground in addition to the ground that is separated from the front end of the vehicle 20 by the predetermined distance L0 or more in the x direction toward the front. When the camera lens 15 is not inclined with respect to the horizontal plane, the image-capturing range A2 includes not only the front ground but also the region above the front ground, which is advantageous for enlarging the image-capturing range A2.

The housing part 12 houses the camera body 11 therein. In the housing part 12, two holes in which the camera lenses 15 are installed are separated in the y direction when viewed from the front to the rear in the x direction. The housing part 12 includes a lower surface 17 which faces an upper surface 28 of the dashboard 25 and is convex in an arc shape toward an upper surface 28. It is preferable that a rear end portion of the lower surface 17 in the x direction is disposed above a front end portion of the lower surface 17 in the x direction.

The leg parts 13 extend from both end portions in the y direction of the housing part 12 toward the upper surface 28 of the dashboard 25. The leg parts 13 support the housing part 12 at a position within the wiping range A1 of the wiper 27 on the windshield 26 in a front view.

Specifically, the leg parts 13 preferably support the lower surface 17 of the housing part 12 above the lower end of the wiping range A1, and more preferably support the lower surface 17 of the housing part 12 above an upper end of the wiping body of the wiper 27. Further, the leg parts 13 preferably support the housing part 12 at a position visible when the driver consciously views a region below the image-capturing range A2 of the camera body 11. That is, when the driver is consciously viewing the front of the vehicle 20, the leg parts 13 preferably support the housing part 12 at a position where the housing part is in the driver's field-of-view but does not make the driver feel bothersome.

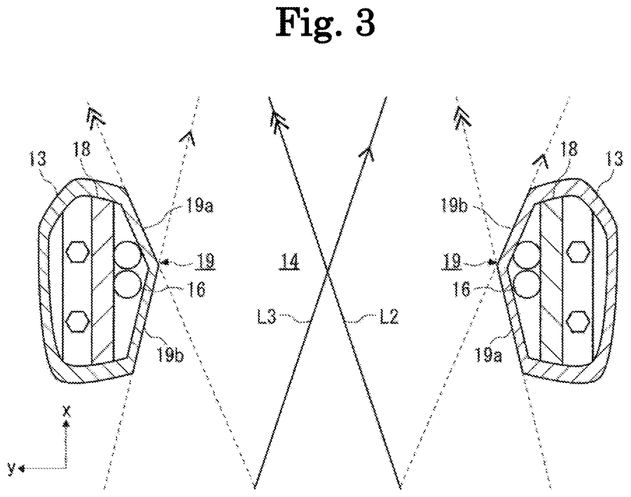

As illustrated in FIG. 3, the leg part 13 is hollow and includes a reinforcing member 18 and houses a cable such as the signal line 16 of the camera body 11.

In a cross-sectional view of the leg part 13, an inner portion 19 in contact with the space 14 is formed in a mountain shape which is convex toward the space 14. In the cross-sectional view of the leg part 13, a first visual axis surface 19a substantially parallel to a visual axis L2 when the driver seated on the driver seat 24 views the front of the vehicle 20 from the space 14 is formed on a side of the space 14 of the inner portion 19. In the cross-sectional view of the leg part 13, a second visual axis surface 19b substantially parallel to a visual axis L3 when an occupant seated on a front passenger seat (not shown) which is disposed on a side of the driver seat in the y direction views the front of the vehicle 20 from the space 14 is formed on a side of the space 14 of the inner portion 19.

The front end of the first visual axis surface 19a in the x direction is shifted leftward in the y direction with respect to the rear end, and is inclined leftward in the y direction with respect to the x direction. The front end of the second visual axis surface 19b in the x direction is shifted rightward in the y direction with respect to the rear end, and is inclined rightward in the y direction with respect to the x direction.

When the driver seat 24 is installed on a right side of the cabin 23, for the leg part 13 on the left side in the y direction, the first visual axis surface 19a is disposed on the front side in the x direction, and the second visual axis surface 19b is disposed on the rear side. For the leg part 13 on the right side in the y direction, the second visual axis surface 19b is disposed on the front side in the x direction, and the first visual axis surface 19 a is disposed on the rear side.

The space 14 is a space surrounded by the dashboard 25, the housing part 12, and the leg parts 13, and specifically, is a space surrounded by the upper surface 28 of the dashboard 25, the lower surface 17 of the housing part 12, and the inner portions 19 of both leg parts 13.

The space 14 is a space in which the driver seated on the driver seat 24 and an occupant seated on the front passenger seat can see the front of the vehicle 20 through the windshield 26. The space 14 is a space from which a range on a ground side can be seen by the occupant, the range excluding the image-capturing range A2 which is in front of the vehicle 20 and captured by the camera body 11.

A3 in FIG. 1 shows a region which is in front of the vehicle 20 and cannot be seen due to the housing part 12 by installing the on-board camera 10 on the upper surface 28 of the dashboard 25. The invisible region A3 is formed in a substantially C shape or a U shape opened downward in a rear view seen from the driver and a front seat passenger.

A region A4 in FIG. 1 shows a region which is in front of the vehicle 20 and can be seen through the windshield 26 because of the space 14. The visible region A4 is surrounded by the dashboard 25 and the invisible region A3. The visible region A4 is a region which is located below the image-capturing range A2 of the camera body 11, cannot be captured by the camera body 11, and needs to be directly visually recognized by the driver or the front seat passenger.

In this way, according to the on-board camera 10, by forming the space 14 surrounded by the dashboard 25, the housing part 12, and the leg parts 13, the field-of-view of the occupant can be sufficiently ensured by the space 14. Therefore, the on-board camera 10 can be installed at a position above the upper surface 28 of the dashboard 25 so as to block the field-of-view of the occupant. Accordingly, this is advantageous for capturing the image of the area in front of the vehicle 20 through the wiping range A1 of the wiper 27 of the windshield 26 without inclining the camera lenses 15 downward, and even if the cabin 23 is at a high position from the ground as in the non-bonnet type vehicle 20, it is possible to widen the captured image-capturing range A2 in front of the vehicle 20 and make the image clear. Accordingly, the front of the vehicle 20 can be monitored with high accuracy.

In the on-board camera 10, the space 14 is a space from which a range on a ground side in front of the vehicle 120 can be seen by the driver or the front seat passenger, the range excluding the image-capturing range A2 captured by the camera body 11. That is, the space 14 is a space for visually recognizing the visible region A4 located below the image-capturing range A2 captured by the camera body 11. In this way, the driver or the front seat passenger can see the range that cannot be captured by the camera body 11, which is advantageous for improving safety.

In the cross-sectional view of the leg part 13, the on-board camera 10 described-above is formed with the first visual axis surface 19a substantially parallel to the visual axis L2 when the driver views the front of the vehicle 20 from the space 14 on a side of the space 14 of the leg part 13. As described above, the reinforcing member 18 and the cable such as the signal line 16 are housed inside the leg part 13, and the area inside the leg part 13 in the cross-sectional view cannot be reduced. Therefore, by forming the first visual axis surface 19a without reducing the area inside the leg part 13, it is possible to increase the y direction width of the space 14 when the driver views the space 14, which is advantageous in improving the visibility.

Further, since the on-board camera 10 also forms the second visual axis surface 19b in addition to the first visual axis surface 19a on the leg part 13, it is possible to increase the width of the space 14 in the y direction when the front seat passenger sees the space 14, which is advantageous in improving the visibility.

By forming both the first visual axis surface 19a and the second visual axis surface 19b in one leg part 13, in the cross-sectional view of the leg part 13, the inner portion 19 in contact with the space 14 is formed in a mountain shape which is convex toward the space 14. As described above, the mountain shape is advantageous in improving the visibility, and also has excellent design properties.

The above-described on-board camera 10 is installed on the upper surface 28 of the dashboard 25. Therefore, the on-board camera 10 is optimal as an installation location of a sensor such as a sunshine sensor required for adjustment of an internal temperature of the cabin 23 by an in-vehicle air conditioner and an auto light sensor required for adjusting whether a headlight that illuminates the front of the vehicle 20 is turned on. It is also possible to install a camera that captures an image of a face direction of the driver at the rear end in the x direction.

The present application is based on the Japanese Patent Application (No. 2017-082481) filed on Apr. 19, 2017, contents of which are incorporated herein as reference.

### INDUSTRIAL APPLICABILITY

The on-board camera according to the present disclosure is useful in that the field-of-view of the occupant is sufficiently ensured, a wide range in front of the non-bonnet type vehicle is captured clearly, and the front of the vehicle is monitored with high accuracy.

### LIST OF REFERENCE NUMERALS

10 on-board camera
11 camera body
12 housing part
13 leg part
14 space
20 vehicle
24 driver seat
25 dashboard
26 windshield
27 wiper
28 upper surface
A1 wiping range

1. An on-board camera that captures an image of an area in front of a vehicle, the on-board camera comprising:
a camera body;
a housing part that houses the camera body; and
a leg part that extends from the housing part toward an upper surface of a dashboard of the vehicle,
wherein the leg part supports the housing part at a position where the housing part is placed within a wiping range of a wiper on a windshield of the vehicle when the housing part is viewed from a front-rear direction of the vehicle,
a space surrounded by the dashboard, the housing part, and the leg part is formed, and
an occupant seated on a seat of the vehicle enables to see an area in front of the vehicle through the windshield from the space.

2. The on-board camera according to claim 1,
wherein the space is a space from which a range on a ground side is seen by the occupant, the range excluding an image-capturing range which is in front of the vehicle and captured by the camera body.

3. The on-board camera according to claim 1,
wherein in a cross-sectional view of the leg part, the leg part has a surface on a side of the space, the surface being substantially parallel to a visual axis when a driver seated on a driver seat among the seats views the ground in front of the vehicle from the space.

4. The on-board camera according to claim 3,
wherein in the cross-sectional view of the leg part, the leg part has a surface on a side of the space, the surface being substantially parallel to a visual axis when an occupant seated on a front passenger seat among the seats views the ground in front of the vehicle from the space.

5. The on-board camera according to claim 3,
wherein a lower surface of the housing part faces the upper surface of the dashboard, and a rear end portion of the lower surface in the front-rear direction of the vehicle is disposed above a front end portion of the lower surface.

6. The on-board camera according to claim 1,
wherein the camera body is configured by a stereo camera, and a plurality of camera lenses are separated in a left-right direction of the vehicle and disposed in the housing part at a central portion in the left-right direction on the upper surface of the dashboard,
the leg parts extend from both end portions of the housing part in the left-right direction toward the dashboard respectively, and
the space is formed between the leg parts.
